(19) United States
(12) Patent Application Publication
(10) Pub. No.: US 2023/0158617 A1
(43) Pub. Date: May 25, 2023

(54) MACHINING APPARATUS AND MACHINING END DETECTION METHOD

(71) Applicant: National University Corporation Tokai National Higher Education and Research System, Aichi-ken (JP)

(72) Inventor: Eiji SHAMOTO, Aichi-ken (JP)

(21) Appl. No.: 18/156,087

(22) Filed: Jan. 18, 2023

Related U.S. Application Data
(63) Continuation of application No. PCT/JP2021/035253, filed on Sep. 27, 2021.

(51) Int. Cl. B23K 37/047; B23K 26/03; B23K 26/38; B23K 26/082

(52) U.S. Cl. CPC B23K 37/047; B23K 26/032; B23K 26/38; B23K 26/082

(57) ABSTRACT

A feed mechanism moves a workpiece relative to a cylindrical machining region of laser light. A light receiver receives the laser light that has passed through without being used for machining the workpiece. An intensity detector detects light intensity of the laser light thus received. A controller detects the end of machining on the basis of the light intensity thus detected.

### CROSS REFERENCE TO RELATED APPLICATIONS

This application is based upon and claims the benefit of priority from International Application No. PCT/JP2021/035253, filed on Sep. 27, 2021, the entire contents of which are incorporated herein by reference.

### BACKGROUND

### 1. Field of the Disclosure

The present disclosure relates to a technique for detecting end of machining using laser light.

### 2. Description of the Related Art

As a machining method using laser light, pulse laser grinding is known in which pulsed laser light is concentrated, and a cylindrical irradiation region including the focused spot is scanned over a surface of a workpiece to perform surface machining. JP 2016-159318 A discloses a method of overlapping an irradiation region of pulsed laser light that extends in a cylindrical shape and has energy enough to make machining with a surface-side portion of a workpiece and scanning the irradiation region at a speed that allows machining to remove a surface region of the workpiece. Hiroshi Saito, Hongjin Jung, Eiji Shamoto, Shinya Suganuma, and Fumihiro Itoigawa; “Mirror Surface Machining of Steel by Elliptical Vibration Cutting with Diamond-Coated Tools Sharpened by Pulse Laser Grinding”, International Journal of Automation Technology, Vol. 12, No. 4, pp. 573-581 (2018) discloses a technique of machining a flank face of a tool base material in two directions by pulse laser grinding to form a V-shaped cutting edge.

FIGS. 1A and 1B are diagrams showing a method of sharpening a cutting edge (tool tip) of a diamond-coated tool by pulse laser grinding disclosed in Hiroshi Saito, Hongjin Jung, Eiji Shamoto, Shinya Suganuma, and Fumihiro Itoigawa; “Mirror Surface Machining of Steel by Elliptical Vibration Cutting with Diamond-Coated Tools Sharpened by Pulse Laser Grinding”, International Journal of Automation Technology, Vol. 12, No. 4, pp. 573-581 (2018). FIG. 1A shows a state where pulse laser grinding is performed on a rake face, and FIG. 1B shows a state where pulse laser grinding is performed on a flank face in two directions.

In the process of sharpening the cutting edge by pulse laser grinding, laser light slightly cuts into the cutting edge, and in this state, feed motion along a cutting edge ridge is repeatedly imparted between the laser light and the cutting edge. The second and subsequent machining using the same feed motion is called “zero cutting”.

For the process of sharpening the cutting edge, the required number of repetitions for zero cutting is unknown. Therefore, under the present circumstances, zero cutting is performed more than the number of times estimated from experience, or is performed a plurality of times until an operator confirms the end of machining visually or using an image taken by a camera. The former approach is not efficient because zero cutting may be unnecessarily performed, and the latter approach is not suitable for automation. It is therefore desired to develop a technique for detecting the end of machining by pulse laser grinding. Note that the technique for detecting the end of machining by pulse laser grinding is useful not only for the process of sharpening a cutting edge but also for other types of machining processes.

### SUMMARY

The present disclosure has been made in view of such circumstances, and it is therefore an object of the present disclosure to provide a technique for detecting the end of machining using laser light.

In order to solve the above-described problems, one aspect of the present disclosure is a machining apparatus that machines a workpiece by scanning a cylindrical machining region including a focused spot of laser light, the machining apparatus including a feed mechanism structured to move a workpiece relative to a cylindrical machining region of laser light, a light receiver structured to receive the laser light that has passed through without being used for machining the workpiece, an intensity detector structured to detect light intensity of the laser light received, and a controller structured to detect end of machining on the basis of the light intensity detected.

Another aspect of the present disclosure is a machining end detection method of a machining apparatus that machines a workpiece by scanning a cylindrical machining region including a focused spot of laser light, the method including moving a workpiece relative to a cylindrical machining region of laser light, receiving the laser light that has passed through without being used for machining the workpiece, detecting light intensity of the laser light received, and detecting end of machining on the basis of the light intensity detected.

### BRIEF DESCRIPTION OF THE DRAWINGS

FIGS. 1A and 1B are diagrams showing a method of sharpening a cutting edge of a diamond-coated tool;

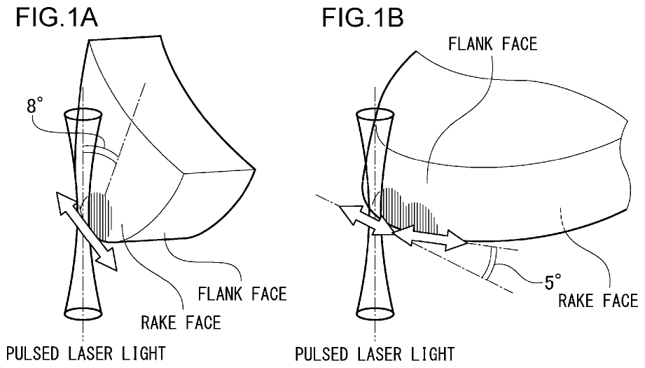

FIG. 2 is a diagram for describing pulse laser grinding;

FIG. 3 is a diagram showing a schematic structure of a laser machining apparatus;

FIGS. 4A, 4B, 4C, and 4D are diagrams for describing a process of detecting the end of machining in the laser machining apparatus;

FIG. 5A is a diagram showing a temporal change in feed amount, and FIG. 5B is a diagram showing a temporal change in light intensity;

FIG. 6 is a diagram showing pulse laser grinding for sharpening a cutting edge;

FIG. 7 is a diagram showing a relationship between light intensity detected during the process of sharpening a cutting edge and a machining position;

FIG. 8 is a diagram showing an example of a detection result of light intensity; and

FIG. 9 is a diagram showing another example of the detection result of light intensity.

### DETAILED DESCRIPTION

The disclosure will now be described by reference to the preferred embodiments. This does not intend to limit the scope of the present disclosure, but to exemplify the disclosure.

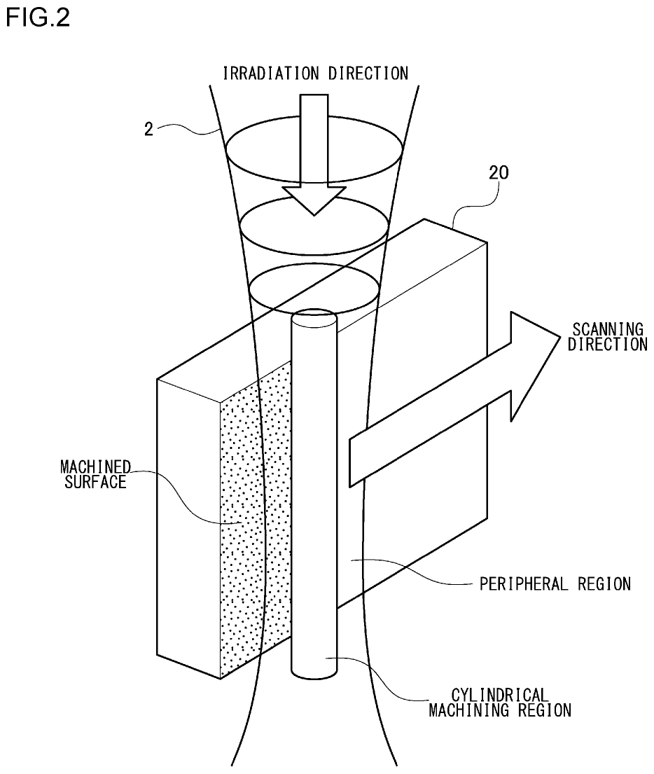

FIG. 2 is a diagram for describing pulse laser grinding. Laser light 2 used for the pulse laser grinding has a light intensity distribution close to a Gaussian distribution when viewed along a cross section orthogonal to an optical axis of the laser light 2. The laser light 2 is focused near a workpiece 20, and when the workpiece 20 is irradiated with a region having a high energy density at the focus position, the workpiece 20 is melted and evaporated for removal.

When an approximately cylindrical region extending in an optical axis direction and having energy enough to make machining at the focus position is referred to as a “cylindrical machining region”, and during the pulse laser grinding, the cylindrical machining region including the focused spot of the laser light 2 is scanned in a direction intersecting the optical axis with the cylindrical machining region overlapping the surface of the workpiece 20 so as to remove a surface region of the workpiece 20 irradiated with the cylindrical machining region. In the pulse laser grinding, a surface parallel to the optical axis direction and scanning direction is formed on the surface of the workpiece 20. Note that an energy density of a peripheral region located outside the cylindrical machining region is not sufficient to remove the surface region of the workpiece 20, so that, even when the workpiece 20 is irradiated with the peripheral region, the workpiece 20 is not machined. A boundary between the cylindrical machining region and peripheral region of the cylindrical machining region is determined in a manner that depends on a material of the workpiece 20 and specifications of the laser light 2.

In the laser machining in the related art, all the laser light is applied to the surface of the workpiece, but in the pulse laser grinding machining, only a part of the laser light 2 obliquely impinges on the surface of the workpiece 20, and the rest of the laser light 2 passes through the workpiece 20. That is, only a part of the energy of the laser light 2 is used for removing the workpiece 20, and most of the other energy is not used for machining the workpiece 20. The embodiment proposes a technique for detecting, using the laser light 2 that has passed through without being used for machining the workpiece 20, the end of machining with the laser light 2.

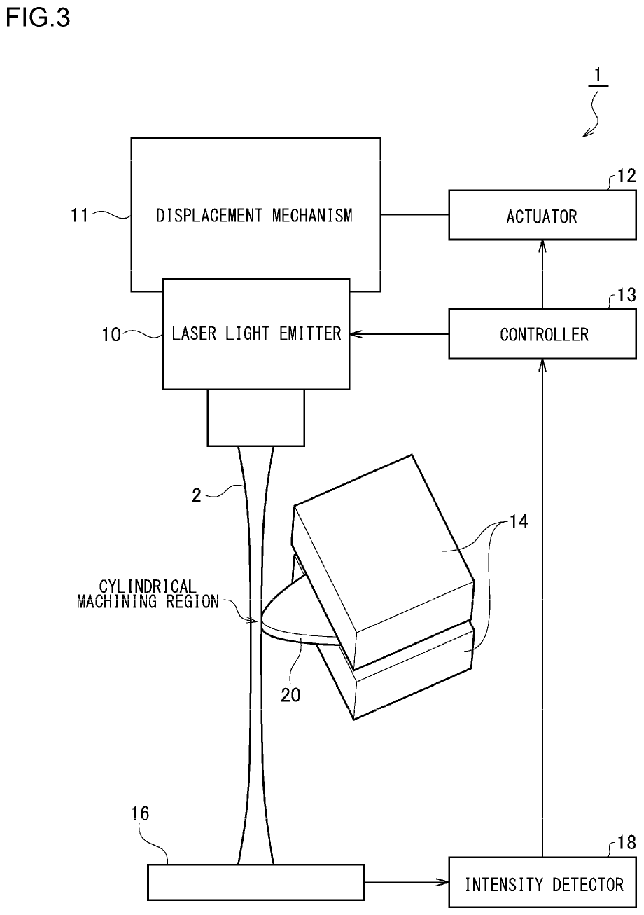

FIG. 3 shows a schematic structure of a laser machining apparatus 1 that performs pulse laser grinding. The laser machining apparatus 1 includes a laser light emitter 10 that emits the laser light 2, a support device 14 that supports the workpiece 20, a displacement mechanism 11 that enables the laser light emitter 10 to move relative to the workpiece 20, an actuator 12 that realizes the relative movement between the light emitter 10 and the workpiece 20 by the displacement mechanism 11, and a controller 13 that collectively controls operation of the laser machining apparatus 1. The controller 13 controls the actuator 12 to realize the relative movement between the light emitter 10 and the workpiece 20 by the displacement mechanism 11. The displacement mechanism 11 and the actuator 12, each of which includes at least one motor, constitute a feed mechanism that moves the workpiece 20 relative to the cylindrical machining region of the laser light 2. In the embodiment, the workpiece 20 is a cutting tool, and the laser machining apparatus 1 performs pulse laser grinding for sharpening the cutting edge (tool tip) of the cutting tool, but the workpiece 20 may be a workpiece of a different type. In the embodiment, the controller 13 is implemented by hardware such as an arbitrary processor, memory, auxiliary storage, or other LSIs and by software such as a program or the like loaded into the memory.

The laser light emitter 10 includes components such as a laser oscillator that generates laser light, an attenuator that adjusts output of the laser light, and a mirror that changes a direction of the laser light, and is structured to output, through an optical lens, the laser light 2 that has passed through the components to be concentrated. For example, the laser oscillator may generate Nd: YAG pulsed laser light.

The feed mechanism according to the embodiment changes a relative position of the laser light emitter 10 relative to the workpiece 20, and may also include a mechanism for changing a relative orientation. The actuator 12 drives the displacement mechanism 11 in accordance with a command from the controller 13 to change the relative position of the laser light emitter 10 relative to the workpiece 20 and further to change the relative orientation as necessary. Note that, in the laser machining apparatus 1 shown in FIG. 3, the displacement mechanism 11 changes the position of the laser light emitter 10 and further changes the orientation as necessary. However, in a case where it is preferable that the laser light emitter 10 be stationary, the displacement mechanism 11 may change the position of the support device 14 and further change the orientation as necessary. In any case, the feed mechanism has a mechanism for moving the workpiece 20 relative to the cylindrical machining region of the laser light 2 and changing the orientation of the workpiece 20 relative to the cylindrical machining region of the laser light 2 as necessary.

The laser machining apparatus 1 according to the embodiment includes a light receiver 16 that receives the laser light emitted from the laser light emitter 10. The light receiver 16 includes light-receptive elements, for example, photodiode, phototransistor, etc. The light receiver 16 includes a light receiving surface facing a laser light emitting port, and is disposed at a position away from the laser light emitting port by a predetermined distance. When the laser light emitter 10 is moved by the feed mechanism, the light receiver 16 may be moved together with the laser light emitter 10 while maintaining a relative positional relationship with the laser light emitter 10. Note that the light receiver 16 need not necessarily receive all the laser light, and may receive the laser light whose light intensity is lowered to a certain degree by a splitter or an attenuator.

The pulse laser grinding is a machining method by which a surface parallel to the optical axis direction and the scanning direction of the laser light 2 is formed on the surface of the workpiece 20, so that only a part of the laser light 2 is used for material removal of the workpiece 20, and most of the laser light 2 passes through without being used for machining the workpiece 20. The light receiver 16 according to the embodiment is disposed to face the laser light emitting port, and receives the laser light 2 that has passed through the workpiece 20 without being used for machining the workpiece 20. Intensity detector 18 detects the light intensity of the laser light received by light receiver 16. The light receiver 16 and the intensity detector 18 may be separate from each other, or may be inseparable from each other.

Since the laser machining apparatus 1 according to the embodiment performs pulse laser grinding, the light receiver 16 receives the laser light 2 that blinks in an extremely short pulse period. The intensity detector 18 may detect light intensity obtained by evaluating the laser light 2 received by the light receiver 16 over a period longer than or equal to each pulse period. For example, the intensity detector 18 may detect a time mean value obtained by averaging light intensity over a period longer than or equal to each pulse period or may detect a peak value in a period equal to each pulse period.

The laser light 2 used for pulse laser grinding is emitted so as to be focused near the workpiece 20, and has highest energy density near the workpiece 20. In order to prevent the light receiver 16 from being damaged and deteriorated, the light receiver 16 is preferably installed at a position away by a certain distance from the cylindrical machining region including the focused spot. For example, it is preferable that the distance from the workpiece 20 to the light receiver 16 be set greater than or equal to a distance L from the optical lens that concentrates the laser light from the laser light emitter 10 to the workpiece 20.

The laser machining apparatus 1 according to the embodiment has a function of detecting the end of machining with the laser light 2.

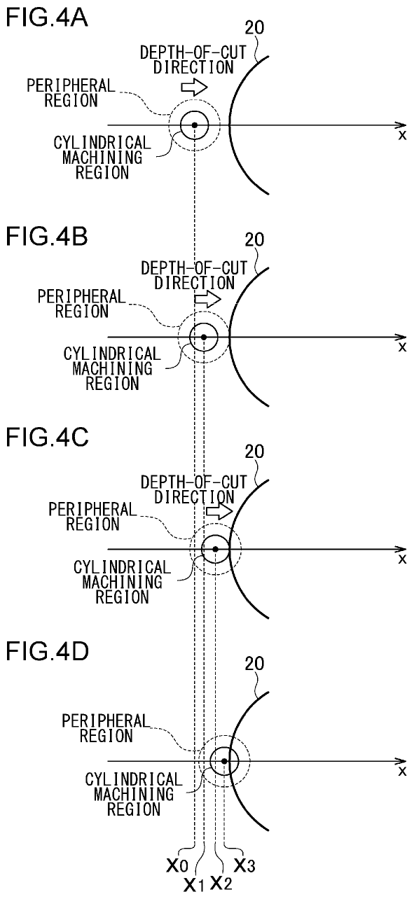

FIGS. 4A to 4D are diagrams for describing a process of detecting the end of machining in the laser machining apparatus 1. FIGS. 4A to 4D shows a state where the feed mechanism moves the laser light 2 to the workpiece 20 in a depth-of-cut direction (in a direction in which the laser light 2 comes close to the workpiece 20), or alternatively, the feed mechanism may move the workpiece 20 toward the laser light 2. Here, the feed direction is the x-axis positive direction, and the feed rate v is constant.

FIG. 4A shows a state where the x coordinate of the center of the optical axis of the laser light 2 is at an initial position x₀. From this state, the feed mechanism moves the laser light 2 in the depth-of-cut direction at the constant rate v. As described above, the cylindrical machining region surrounded by the solid line circle has energy density enough to make machining, and the peripheral region outside the cylindrical machining region and surrounded by the dotted line circle has no energy density enough to make machining.

FIG. 4B shows a state at the moment when an outermost peripheral portion of the peripheral region of the laser light 2 comes into contact with the workpiece 20. The x coordinate of the center of the laser optical axis at this time is x₁. Note that even when the workpiece 20 is irradiated with the peripheral region, the workpiece 20 is not machined because the energy density of the peripheral region is low, and the emitted laser light 2 (peripheral region) heats the surface of the workpiece 20 and partially reflects and scatters.

FIG. 4C shows a state at the moment when the outermost peripheral portion of the cylindrical machining region of the laser light 2 comes into contact with the workpiece 20, that is, at the moment when cutting starts. The x coordinate of the center of the laser optical axis at this time is x₂. When the feed mechanism continues to move the laser light 2 at the constant rate v, the area of the cylindrical machining region applied to the workpiece 20 gradually increases.

FIG. 4D shows a state where the cylindrical machining region of the laser light 2 is partially applied to the workpiece 20. The x coordinate of the center of the laser optical axis at this time is x₃, and the feed mechanism stops the feed motion of the laser light 2 at this position.

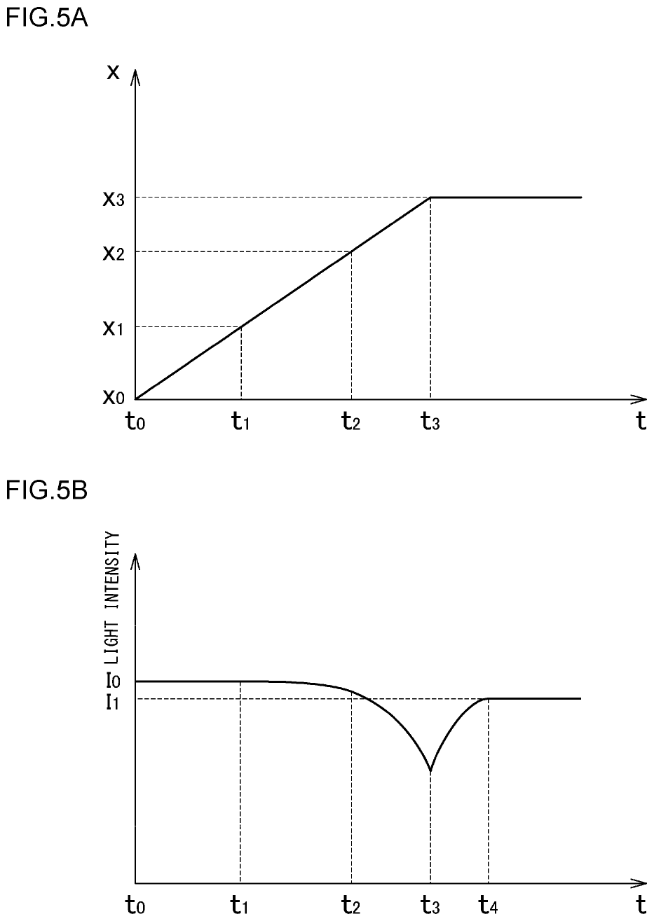

FIG. 5A shows a temporal change in the feed amount. FIG. 5A shows the feed motion of the laser light 2 during a period from time t₀ to time t₃ during which the center of the optical axis of the laser light 2 is moved at the constant rate v from x₀ to x₃ and is then stopped moving. To be exact, a short acceleration/deceleration period exists at the start and end of the uniform motion, but is not shown in FIG. 5A.

FIG. 5B shows a temporal change in the light intensity detected by the intensity detector 18. An initial value I₀ of the light intensity is light intensity detected by the intensity detector 18 when the workpiece 20 is not irradiated with the laser light 2. As described above, the intensity detector 18 according to the embodiment detects light intensity obtained by evaluating the laser light 2 received by the light receiver 16 during a period equal to or longer than the pulse period. Therefore, the initial value I₀ is a value obtained by evaluating the laser light 2 received by the light receiver 16 during a period equal to or longer than the pulse period when the workpiece 20 is not irradiated with the laser light 2. The controller 13 according to the embodiment has a function of monitoring the light intensity detected by the intensity detector 18 and detecting the end of machining on the basis of the light intensity thus detected.

As shown in FIGS. 4A and 4B, the workpiece 20 is not irradiated with the laser light 2 while the center of the optical axis moves from x₀ to x₁ (that is, during a period from time t₀ to time t₁), so that the light intensity detected by the intensity detector 18 does not change from the initial value I₀ serving as a reference value. When the light intensity is constant at the initial value I₀, the controller 13 determines that the workpiece 20 is not irradiated with the laser light 2.

During a period from time t₁ to time t₂, the peripheral region of the laser light 2 is applied to the workpiece 20 to heat the surface of the workpiece 20 to such an extent that the surface is neither melted nor evaporated, and partially reflects and scatters. At this time, when the light receiving surface of the light receiver 16 is wide enough to receive most of the reflected light and the scattered light, the amount of decrease in the light intensity detected by the intensity detector 18 from the initial value I₀ is small. However, when the light receiver 16 fails to receive most of the reflected light and the scattered light, the light intensity detected by the intensity detector 18 decreases more from the initial value I₀. In FIG. 5B, while the center of the optical axis moves from x₁ to x₂ (that is, from time t₁ to time t₂), the peripheral region of the laser light 2 is partially absorbed and used for heating the workpiece 20, and the light receiver 16 does not receive a part or all of the reflected light and the scattered light, so that the light intensity detected by the intensity detector 18 gradually decreases from the initial value I₀.

When the cylindrical machining region of the laser light 2 starts to cut into the workpiece 20 at time t₂, the energy of the laser light that has cut (entered) into the workpiece 20 is used for machining the workpiece 20, and the amount of decrease in the light intensity detected by the intensity detector 18 becomes larger. The controller 13 may determine that the laser light 2 emitted from the laser light emitter 10 has started to cut into the workpiece 20 at the timing when the amount of decrease in the light intensity detected by the intensity detector 18 becomes larger. In this example, at the timing of time t₂, that is, when the x coordinate of the center of the optical axis becomes x₂, the controller 13 may determine that the outermost peripheral portion of the cylindrical machining region has started to cut into the workpiece 20. This determination allows the controller 13 to estimate and monitor the depth of cut of subsequent pulse laser grinding in real time on the basis of the coordinate value of x₂.

In the example of the feed motion shown in FIG. 5A, the feed mechanism moves the center of the optical axis of the laser light 2 to x₃ and then stops. As shown in FIG. 5B, during a period from time t₂ to time t₃, the light intensity detected by the intensity detector 18 decreases as the area of the cylindrical machining region of the laser light 2 applied to the workpiece 20 increases, and the energy density of the irradiation region increases.

When the feeding motion of the laser light 2 is stopped at time t₃ (the state shown in FIG. 4D), the material removal by the cylindrical machining region proceeds in the traveling direction of the laser light 2 with the lapse of time, and the laser light passing through (penetrating) the workpiece 20 increases. During a period from time t₃ to time t₄, the light intensity detected by the intensity detector 18 increases, and returns to I₁ close to the initial value I₀ at time t₄. After time t₄, the light intensity detected by the intensity detector 18 no longer changes from I₁. The fact that the light intensity detected by the intensity detector 18 no longer changes means that the workpiece 20 machined by the cylindrical machining region of the laser light 2 has disappeared (completely removed).

After time t₁, a part of the peripheral region of the laser light 2 applied to the workpiece 20 is absorbed by the surface of the workpiece 20 to heat the workpiece 20, and the other part of the peripheral region reflects and scatters off the surface of the workpiece 20, and most of the reflected light and scattered light passes through the workpiece 20. Since the light receiver 16 according to the embodiment does not receive a part or all of the absorbed light, the reflected light, and the scattered light, the light intensity detected by the intensity detector 18 is I₁ lower than the initial value I₀ after time t₄ when all the cylindrical machining region penetrates the workpiece 20. That is, it can be said that the amount of decrease (I₀−I₁) from the initial value of the light intensity corresponds to the sum of the light intensity of the absorbed light, the light intensity of the reflected light, and the light intensity of the scattered light that have not been received by the light receiver 16.

As described above, the light intensity detected by the intensity detector 18 changes during machining by the cylindrical machining region, and when the machining by the cylindrical machining region ends, the light intensity detected by the intensity detector 18 no longer changes. Therefore, the controller 13 according to the embodiment may detect the end of machining on the basis of a change in the light intensity detected by the intensity detector 18. Specifically, the controller 13 monitors the light intensity detected by the intensity detector 18, and detect, when an increase in the light intensity stops, that is, when the detected light intensity no longer increases, the end of machining.

Note that the controller 13 may detect the end of machining on the basis of the value of increasing light intensity instead of a change in the light intensity. Specifically, when the light intensity detected by the intensity detector 18 during machining with the laser light 2 becomes equal to or greater than a predetermined threshold Iₜₕ, the controller 13 detects the end of machining. Here, the threshold Iₜₕ may be a value obtained by multiplying the initial value I₀ by a value α less than 1. That is, the threshold Iₜₕ is obtained as follows:

Iₜₕ=α*I₀. Here, α is set in a manner that depends on the material of the workpiece 20, the specifications of the laser light 2, and the depth of cut into the workpiece 20 by the laser light 2, and may be set greater than or equal to 0.8 and less than 1, for example, a value within a range of 0.93 to 0.97.

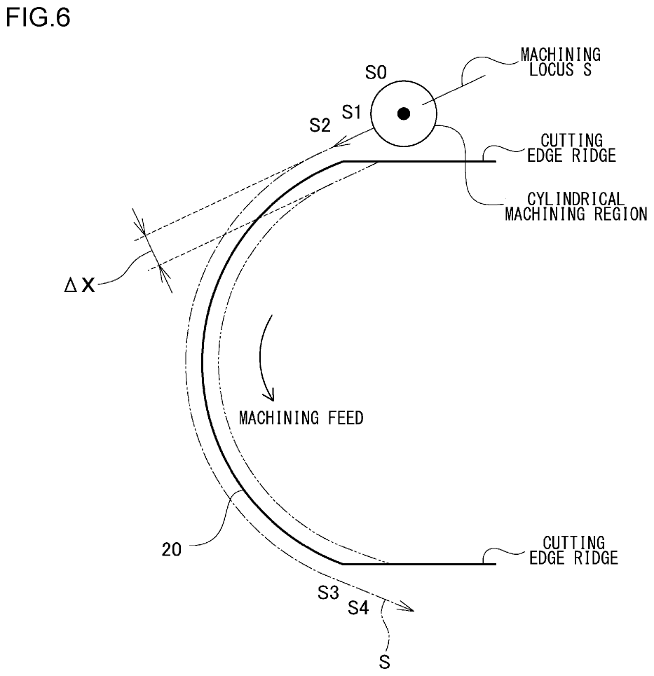

FIG. 6 shows an example of pulse laser grinding for sharpening a cutting edge (tool tip). In the process shown in FIG. 6, the feed mechanism moves the cutting edge that is the workpiece 20 relative to the cylindrical machining region of the laser light 2 a plurality of times along a predetermined machining locus S to machine the cutting edge. Specifically, the feed mechanism causes the cylindrical machining region to slightly enter into the cutting edge, and repeatedly imparts, in this state, the feed motion at the constant rate along the cutting edge ridge between the laser light 2 and the cutting edge so as to sharpen the cutting edge.

The machining locus S represents a locus along which the optical axis of the laser light 2 moves. In the process of sharpening the cutting edge, the cylindrical machining region is fed along the machining locus S to cutting edge a plurality of times. It should be noted that the machining feed may be performed in the same direction each time (counterclockwise direction in the example shown in FIG. 6), but may be alternately performed in the counterclockwise direction and the clockwise direction. The feed rate is preferably set constant.

A machining position S0 indicates the start point of the machining locus S in the counterclockwise direction. The cylindrical machining region starts to cut into the cutting edge at a machining position S1, cuts into the cutting edge by approximately uniform depth of cut from a machining position S2 to a machining position S3, moves away from the cutting edge at a machining position S4, and brings one machining feed to an end. A machining range from the machining position S2 to the machining position S3 in which the depth of cut is approximately uniform, is referred to as a steady machining range. In the process of sharpening the cutting edge, this machining feed is repeated a plurality of times to gradually machine (remove) the cutting edge material.

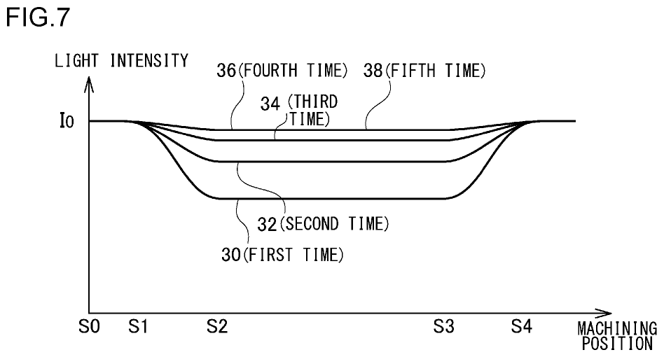

FIG. 7 shows a relationship between the light intensity detected during the process of sharpening the cutting edge shown in FIG. 6 and the machining position on the machining locus S. An initial value I₀ of the light intensity is light intensity detected by the intensity detector 18 when the workpiece 20 is not irradiated with the laser light 2. Referring to FIG. 6, it should be noted that the interval between S1 and S2 and the interval between S3 and S4 are extremely short as compared with the interval between S2 and S3, but in FIG. 7, for convenience of description, the interval between S1 and S2 and the interval between S3 and S4 are made long relative to the interval between S2 and S3.

A detection result 30 indicates light intensity detected at each machining position by the intensity detector 18 during the first machining, and a detection result 32 indicates light intensity detected at each machining position by the intensity detector 18 during the second machining. Likewise, a detection result 34 indicates light intensity detected during the third machining, a detection result 36 indicates light intensity detected during the fourth machining, and a detection result 38 indicates light intensity detected during the fifth machining. In FIG. 7, the detection results 36, 38 are the same and thus coincide with each other.

A result of comparing the detection results 30, 32, 34, 36, shows that the light intensity detected at each machining position increases as the number of times of machining increases. That is, light intensity detected during the N-th machining is higher than light intensity detected during the (N−1)-th machining (2≤N≤4). This is because as the number of times of machining increases, the cutting edge material is gradually removed, and the cylindrical machining region passing through the cutting edge increases.

On the other hand, a result of comparing the detection results 36, 38 shows that the light intensity detected at each machining position is the same between the detection results 36, 38. This is because all of the cutting edge material located in the range where the cylindrical machining region is applied has been removed, and therefore, even when the fifth and subsequent machining feeds are repeated, there is no cutting edge material to be removed, which is wasteful. Therefore, when the light intensity at each machining position detected during the previous machining becomes equal to the light intensity at each machining position detected during the current machining, the controller 13 detects the end of machining.

Note that the case where the light intensity during the previous machining is equal to the light intensity during the current machining may include a case where the light intensity during the previous machining is substantially equal to the light intensity during the current machining. As described above, the light intensity detected by the intensity detector 18 in the embodiment is light intensity evaluated during a period equal to or longer than the pulse period, and is affected by a fluctuation factor such as a motion error of the feed mechanism, a laser output fluctuation, or sensor noise. Therefore, the detected light intensity may possibly contain an error, and thus the controller 13 may determine that the light intensity during the previous machining is substantially equal to the light intensity during the current machining when a difference between the light intensity during the previous machining and the light intensity during the current machining is less than or equal to the threshold. For example, a predetermined proportion (for example, 1%) of the initial value I₀ may be set as the threshold, or when the detected light intensity fluctuates, the standard deviation of the fluctuation*β (β is a value greater than or equal to 1) is set as the threshold.

In particular, when the light intensity detected during the previous machining and the light intensity detected during the current machining become equal to each other in the steady machining range from the machining position S2 to the machining position S3, the controller 13 may detect the end of machining. When detecting the end of machining, the controller 13 determines not to perform next machining (zero cutting). Detecting the end of machining as described above makes it possible to avoid unnecessary zero cutting and to make the process of sharpening the cutting edge more efficient.

Note that the controller 13 may detect the end of machining on the basis of the value of the light intensity detected by the intensity detector 18. Specifically, when a machining range in which the light intensity detected by the intensity detector 18 during machining with the laser light 2 is greater than or equal to the predetermined threshold Iₜₕ becomes equal to or greater than a predetermined range, the controller 13 detects the end of machining. Here, the threshold Iₜₕ may be a value obtained by multiplying the initial value I₀ by a value α less than 1. That is, the threshold Iₜₕ is obtained as follows:

Iₜₕ=α*I0. α is set in a manner that depends on the material of the workpiece 20, the specifications of the laser light 2, and the depth of cut into the workpiece 20 by the laser light 2, and may be set greater than or equal to 0.8 and less than 1, for example, a value within a range of 0.93 to 0.97.

For example, in the fourth detection result 36, when the light intensity detected in the steady machining range from the machining position S2 to the machining position S3 becomes greater than or equal to the predetermined threshold Iₜₕ, the controller 13 may detect the end of machining without performing the fifth machining feed.

Here, referring to the detection result 30 detected during the first machining feed in FIG. 7, the light intensity monotonously decreases from the machining positions S1 to S2, becomes constant from the machining positions S2 to S3, monotonously increases from the machining positions S3 to S4, and returns to the initial value I₀. The controller 13 may monitor whether the pulse laser grinding is appropriately performed on the basis of a change in the intensity during ideal machining shown by the detection result 30.

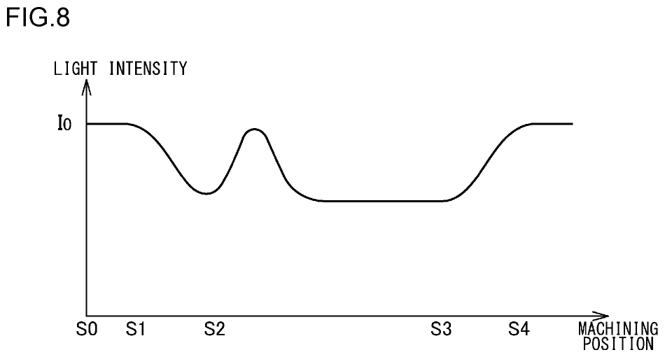

FIG. 8 shows an example of the detection result of the light intensity. In the detection result shown in FIG. 8, the light intensity increases and decreases in a part of the steady machining range. Basically, the fact that the light intensity increases and decreases in a range where the light intensity should be constant indicates that the cutting edge has been damaged.

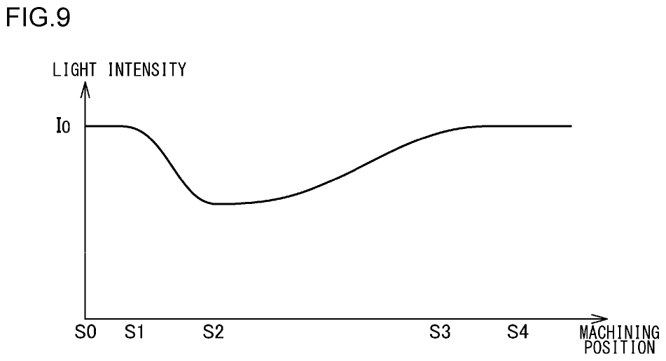

FIG. 9 shows another example of the detection result of the light intensity. In the detection result shown in FIG. 9, the light intensity in the steady machining range monotonically increases. This indicates that the cutting edge ridge is inclined from the machining locus S and the depth of cut in the second half is insufficient.

The controller 13 may determine whether the pulse laser grinding process is appropriately performed on the basis of the light intensity at each machining position. Specifically, when detecting that the light intensity is not constant in the steady machining range in which the light intensity should be constant, the controller 13 may determine that the pulse laser grinding process is not appropriately performed. As shown in FIGS. 8 and 9, a change in the light intensity indicates an error occurring, so that the controller 13 may determine whether the shape of the cutting edge before machining is normal or whether the relative positional relationship between the cutting edge and the machining locus S is correctly set on the basis of the detected change in the light intensity.

The present disclosure has been described on the basis of the embodiment. It is to be understood by those skilled in the art that the embodiments are illustrative and that various modifications are possible for a combination of components or processes, and that such modifications are also within the scope of the present disclosure.

In the embodiment, the process in which the feed mechanism moves the cutting edge that is the workpiece 20 relative to the cylindrical machining region of the laser light 2 a plurality of times along the predetermined machining locus S to machine the cutting edge has been described with reference to FIG. 6, but in a modification, the feed mechanism moves the cutting edge that is the workpiece 20 relative to the cylindrical machining region of the laser light 2 only once along the predetermined machining locus S to machine the cutting edge. In this modification, the controller 13 monitors the light intensity detected at each machining position on the machining locus S, and controls the feed mechanism on condition that the light intensity at each machining position is greater than or equal to the predetermined threshold Iₜₕ to move the workpiece 20 relative to the cylindrical machining region of the laser light 2. As described above, the controller 13 does not move the laser light 2 until machining at the current machining position is completed, and controls, when the light intensity at the current machining position becomes greater than or equal to the predetermined threshold Iₜₕ, the feed mechanism to perform machining at the next (adjacent) machining position, and this process is sequentially performed along the machining locus S, thereby allowing the entire machining to be completed by one machining feed. Alternatively, the controller 13 may continuously relatively move the laser light 2 along the machining locus S, and perform control of keeping the speed of the relative movement low to maintain the detected light intensity greater than or equal to the predetermined threshold Iₜₕ, so as to complete the entire machining by one machining feed.

The outline of an aspect of the present disclosure is as follows. One aspect of the present disclosure is a machining apparatus that machines a workpiece by scanning a cylindrical machining region including a focused spot of laser light, the machining apparatus including a feed mechanism structured to move a workpiece relative to a cylindrical machining region of laser light, a light receiver structured to receive the laser light that has passed through without being used for machining the workpiece, an intensity detector structured to detect light intensity of the laser light received, and a controller structured to detect end of machining on the basis of the light intensity detected.

In the pulse laser grinding, the laser light that is not used for material removal of the workpiece passes through the workpiece, and the controller may detect that the machining is finished based on the intensity of the passed laser light.

The controller may detect the end of machining on the basis of the light intensity thus detected. Specifically, when there is no change in the detected light intensity, the controller may detect the end of machining. When the feed mechanism moves the workpiece relative to the cylindrical machining region of the laser light a plurality of times along a predetermined machining locus to machine the workpiece, the controller may detect the end of machining when light intensity at each machining position detected during previous machining becomes equal to light intensity at each machining position detected during current machining.

When the feed mechanism moves the workpiece relative to the cylindrical machining region of the laser light once along a predetermined machining locus to machine the workpiece, the controller may control the feed mechanism to move the workpiece relative to the cylindrical machining region of the laser light on condition that the light intensity at each machining position is equal to or greater than a predetermined threshold Iₜₕ.

When the light intensity detected by the intensity detector during machining with the laser light becomes greater than or equal to the predetermined threshold Iₜₕ, the controller may detect the end of machining. At this time, the threshold Iₜₕ may be obtained by multiplying the light intensity I₀ detected by the intensity detector when the workpiece is not irradiated with the laser light by a value α less than 1.

Another aspect of the present disclosure is a machining end detection method of a machining apparatus that machines a workpiece by scanning a cylindrical machining region including a focused spot of laser light, the method including moving a workpiece relative to a cylindrical machining region of laser light, receiving the laser light that has passed through without being used for machining the workpiece, detecting light intensity of the laser light received, and detecting end of machining on the basis of the light intensity detected.

In the pulse laser grinding, the laser light that is not used for material removal of the workpiece passes through the workpiece, and the controller may detect that the machining is finished based on the intensity of the passed laser light.

What is claimed is:

1. A machining apparatus that machines a workpiece by scanning a cylindrical machining region including a focused spot of laser light, the machining apparatus comprising:
a feed mechanism structured to move a workpiece relative to a cylindrical machining region of laser light;
a light receiver structured to receive the laser light that has passed through without being used for machining the workpiece;
an intensity detector structured to detect light intensity of the laser light received; and
a controller structured to detect end of machining on the basis of the light intensity detected.

2. The machining apparatus according to claim 1, wherein
the controller detects the end of machining on the basis of a change in the light intensity detected.

3. The machining apparatus according to claim 2, wherein
when there is no change in the light intensity detected, the controller detects the end of machining.

4. The machining apparatus according to claim 1, wherein
when the feed mechanism moves the workpiece relative to the cylindrical machining region of the laser light a plurality of times along a predetermined machining locus to machine the workpiece, the controller detects the end of machining when light intensity at each machining position detected during previous machining becomes equal to light intensity at each machining position detected during current machining.

5. The machining apparatus according to claim 1, wherein
when the feed mechanism moves the workpiece relative to the cylindrical machining region of the laser light once along a predetermined machining locus to machine the workpiece, the controller controls the feed mechanism to move the workpiece relative to the cylindrical machining region of the laser light on condition that the light intensity at each machining position is equal to or greater than a predetermined threshold Iₜₕ.

6. The machining apparatus according to claim 1, wherein
the controller detects the end of machining when the light intensity detected by the intensity detector during machining with the laser light becomes equal to or greater than a predetermined threshold Iₜₕ, and
the threshold Iₜₕ is obtained by multiplying light intensity I₀ detected by the intensity detector when the workpiece is not irradiated with the laser light by a value α less than 1.
